(19) United States
(12) Patent Application Publication
(10) Pub. No.: US 2020/0299543 A1
(43) Pub. Date: Sep. 24, 2020

(54) POLISHING COMPOSITION

(71) Applicant: FUJIMI INCORPORATED, Kiyosu-shi, Aichi (JP)

(72) Inventor: Yasuto ISHIDA, Kiyosu-shi, Aichi (JP)

(73) Assignee: FUJIMI INCORPORATED, Kiyosu-shi, Aichi (JP)

(21) Appl. No.: 16/086,191

(22) PCT Filed: Mar. 9, 2017
(86) PCT No.: PCT/JP2017/009545

§ 371 Date: Sep. 18, 2018

(30) Foreign Application Priority Data
Mar. 24, 2016 (JP) 2016-060631

(51) Int. Cl. C09G 1/02; B24B 37/04; C09K 3/14

(52) U.S. Cl. CPC C09G 1/02; C09K 3/1436; B24B 37/044

(57) ABSTRACT

Provided is a polishing composition which can sufficiently remove defects remaining on the surface of a polished object and which can make the polishing speeds of the respective materials substantially equal to each other when polishing the object to be polished containing a plurality of materials.

A polishing composition used for polishing an object to be polished containing a material having a silicon-silicon bond, a material having a silicon-nitrogen bond, and a material having a silicon-oxygen bond, the polishing composition including: organic acid surface-immobilized silica particles; a wetting agent; and a polishing speed inhibitor for the material having a silicon-silicon bond, wherein the polishing composition has a pH of less than 7.

### TECHNICAL FIELD

The present invention relates to a polishing composition.

### BACKGROUND ART

In recent years, a new fine processing technology has been developed in accordance with high integration and high performance of large scale integration (LSI). A chemical mechanical polishing (CMP) method is one of those technologies, and it is often used in an LSI manufacturing process, particularly in planarizing an interlayer insulating film in a multilayer wiring forming process, forming a metal plug, and forming embedded wiring (damascene wiring).

The CMP has been applied to each step in semiconductor manufacturing, and as one embodiment thereof, for example, application to a gate formation step in transistor manufacturing can be mentioned. At the time of manufacturing a transistor, a composite material such as an object to be polished containing polysilicon (Poly-Si), silicon nitride (SiN), and silicon oxide film (for example, TEOS), may be polished, and there is a need to polish each material at high speed in order to improve productivity.

In order to meet those needs, it is disclosed in JP 2012-40671 A that silicon nitride can be polished at high speed by using colloidal silica in which an organic acid is immobilized.

### SUMMARY OF INVENTION

It is certainly disclosed in JP 2012-40671 A that silicon nitride can be polished at high speed by using colloidal silica in which an organic acid is immobilized.

However, although the polishing composition disclosed in JP 2012-40671 A can polish an object to be polished at high speed, there was a problem in that defects (impurities) remain on the surface of the polished object.

Further, when polishing an object to be polished containing a material having a silicon-silicon bond, a material having a silicon-nitrogen bond, and a material having a silicon-oxygen bond, it is required to polish the object to be polished under a condition that the polishing speeds of the respective materials are substantially equal to each other (that is, polishing speed of material having a silicon-silicon bond:polishing speed of material having a silicon-nitrogen bond:polishing speed of material having a silicon-oxygen bond=1:1:1).

Accordingly, an object of the present invention is to provide a polishing composition which can sufficiently remove defects remaining on the surface of a polished object and which can make the polishing speeds of the respective materials substantially equal to each other when polishing the object to be polished containing a material having a silicon-silicon bond, a material having a silicon-nitrogen bond, and a material having a silicon-oxygen bond.

### Solution to Problem

The inventors of the present invention repeated intensive studies to solve the problems that are described above. As a result, the inventors found out that the problems are solved by a polishing composition used for polishing an object to be polished containing a material having a silicon-silicon bond, a material having a silicon-nitrogen bond, and a material having a silicon-oxygen bond, the polishing composition including: organic acid surface-immobilized silica particles; a wetting agent; and a polishing speed inhibitor for the material having a silicon-silicon bond, wherein the polishing composition has a pH of less than 7.

### DESCRIPTION OF EMBODIMENTS

Hereinafter, the present invention will be described. The present invention will not be limited only to the following embodiments. Further, unless specifically described otherwise, operations and measurements of physical properties or the like are carried out under conditions of room temperature (20° C. to 25° C.)/relative humidity of 40% RH to 50% RH.

The present invention provides a polishing composition, which is used for polishing an object to be polished containing a material having a silicon-silicon bond, a material having a silicon-nitrogen bond, and a material having a silicon-oxygen bond, the polishing composition including: organic acid surface-immobilized silica particles; a wetting agent; and a polishing speed inhibitor for the material having a silicon-silicon bond, wherein the polishing composition has a pH of less than 7.

According to the above constitution, a mechanism, which can sufficiently remove defects remaining on the surface of a polished object and which can make the polishing speeds of the respective materials substantially equal to each other when polishing the object to be polished containing a material having a silicon-silicon bond, a material having a silicon-nitrogen bond, and a material having a silicon-oxygen bond, is presumed as follows.

In order to remove defects (impurities) from the polished object, it is known to perform rinse washing using a wetting agent after a CMP process. Therefore, when a wetting agent (for example, polyvinyl alcohol) is added to the polishing composition disclosed in JP 2012-40671 A, residual defects can be sufficiently removed from the polished object by using this composition. However, the present inventors have found that, when polishing an object to be polished containing a material having a silicon-silicon bond, a material having a silicon-nitrogen bond, and a material having a silicon-oxygen bond, the polishing speed of the material having a silicon-silicon bond greatly increases. Therefore, as a result of investigations, the present inventors have found that by using a combination of a wetting agent and a polishing speed inhibitor (for example, polypropylene glycol) of a material having a silicon-silicon bond, the polishing speeds of the respective materials at the time of polishing the object to be polished can be made substantially equal to each other while maintaining the performance of sufficiently removing defects. Based on the finding, the present invention has been completed.

In the present specification, the “making the polishing speeds equal to each other” means that the ratio of each of the polishing speed of a material having a silicon-silicon bond and the polishing speed of a material having a silicon-oxygen bond to the polishing speed of a material having a silicon-nitrogen bond is within a range of 0.8 to 1.2.

However, such a mechanism is merely a presumption, and does not limit the technical scope of the present invention.

<Object to be Polished>

The object to be polished according to the present invention is not particularly limited as long as it is an object to be polished containing a material having a silicon-silicon bond, a material having a silicon-nitrogen bond, and a material having a silicon-oxygen bond.

Examples of the material having a silicon-silicon bond include polysilicon (Poly-Si), amorphous silicon, monocrystalline silicon, n-type dope monocrystalline silicon, p-type dope monocrystalline silicon, and Si-based alloy such as SiGe.

Examples of the material having a silicon-nitrogen bond include silicon nitride (SiN) and the like.

Examples of the material having a silicon-oxygen bond include tetraethyl orthosilicate (TEOS), black diamond (BD: SiOCH), fluorosilicate glass (FSG), hydrogen silsesquioxane (HSQ), and methyl silsesquioxane (MSQ).

In a preferred embodiment of the present invention, the object to be polished contains Poly-Si, SiN, and TEOS.

<Polishing Composition>

According to an embodiment of the present invention, there is provided a polishing composition, which is used for polishing an object to be polished containing organic acid surface-immobilized silica particles; a wetting agent; and a polishing speed inhibitor for the material having a silicon-silicon bond, wherein the polishing composition has a pH of less than 7.

[Organic Acid Surface-Immobilized Silica Particles]

The polishing composition according to the present invention contains organic acid surface-immobilized silica particles. The organic acid surface-immobilized silica particles are silica particles used as abrasive grains, the surface of which is chemically bonded to an organic acid. The silica particles include fumed silica, colloidal silica and the like, and colloidal silica is particularly preferable. The organic acid is not particularly limited, but is preferably a sulfonic acid or a carboxylic acid. An acidic group derived from the organic group (for example, a sulfo group, a carboxyl group, or the like) is immobilized on the surface of the “organic acid surface-immobilized silica particles” contained in the polishing composition of the present invention by a covalent bonding (through a linker structure, in some cases).

As the organic acid surface-immobilized silica particles, synthetic products may be used, and commercially available products may also be used. Further, the organic acid surface-immobilized silica particles may be used alone, and may also be used as a combination of two or more kinds.

The method of introducing these organic acids into the surface of silica particles is not particularly limited. There is a method of introducing the organic acid into the surface of silica particles in a state where a protective group is bonded to the organic acid group and then eliminating the protective group in addition to a method of introducing the organic acid into the surface of the silica particles in the state of a mercapto group or an alkyl group and then oxidizing the organic acid into a sulfonic acid or a carboxylic acid. Further, it is preferable that the compound used for introducing an organic acid into the surface of silica particles has at least one functional group capable of being an organic acid group, and contains a functional group used for bonding to a hydroxyl group on the surface of the silica particle, a functional group introduced for controlling hydrophobicity/hydrophilicity, a functional group introduced for controlling steric bulkiness, or the like.

The specific method of synthesizing the organic acid surface-immobilized silica particles can be carried out by the method described in for example, “Sulfonic acid-functionalized silica through quantitative oxidation of thiol groups”, Chem. Commun. 246-247 (2003), if sulfonic acid which is one of the organic acids is immobilized to the surface of silica particles. Specifically, silica particles, the surface of which is immobilized with sulfonic acid, can be obtained by coupling a silane coupling agent having a thiol group such as 3-mercaptopropyltrimethoxysilane with the silica particle and then oxidizing the thiol group with hydrogen peroxide. Meanwhile, the synthesis method can be carried out by the method described in for example, “Novel Silane Coupling Agents Containing a Photo Labile 2-Nitrobenzyl Ester for Introduction of a Carboxy Group on the Surface of Silica Gel”, Chemistry Letters, 3, 228-229 (2000) if carboxylic acid is immobilized to the surface of silica particles. Specifically, silica particles, the surface of which is immobilized with carboxylic acid, can be obtained by coupling a silane coupling agent containing photoreactive 2-nitrobenzyl ester with the silica particle and then irradiating with light.

The average primary particle size of the organic acid surface-immobilized silica particles in the polishing composition is preferably 5 nm or more, more preferably 7 nm or more, and further preferably 10 nm or more. As the average primary particle size of the organic acid surface-immobilized silica particles increases, there is an advantage that the polishing speed of an object to be polished by the polishing composition is improved.

The average primary particle size of the organic acid surface-immobilized silica particles in the polishing composition is preferably 50 nm or less, more preferably 45 nm or less, and further preferably 40 nm or less. As the average primary particle size of the organic acid surface-immobilized silica particles decreases, there is an advantage that the occurrence of scratches on the surface of the object to be polished after polishing using the polishing composition can be suppressed. The value of the average primary particle size of the organic acid surface-immobilized silica particles is calculated, for example, based on the specific surface area of the organic acid surface-immobilized silica particles measured by the BET method.

The average secondary particle size of the organic acid surface-immobilized silica particles in the polishing composition is preferably 10 nm or more, more preferably 15 nm or more, and further preferably 20 nm or more. As the average secondary particle size of the organic acid surface-immobilized silica particles increases, there is an advantage that the polishing speed of an object to be polished by the polishing composition is improved.

The average secondary particle size of the organic acid surface-immobilized silica particles in the polishing composition is preferably 100 nm or less, more preferably 90 nm or less, and further preferably 80 nm or less. As the average secondary particle size of the organic acid surface-immobilized silica particles decreases, there is an advantage that the occurrence of scratches on the surface of the object to be polished after polishing using the polishing composition can be suppressed. The value of the average secondary particle size of the silica particles is calculated, for example, based on the specific surface area of the silica particles measured by the light scattering method using laser light.

The content of the organic acid surface-immobilized silica particles in the polishing composition is preferably 0.0005 mass % or more, more preferably 0.001 mass % or more, and further preferably 0.005 mass % or more. As the content of the organic acid surface-immobilized silica particles increases, there is an advantage that the polishing speed of an object to be polished by the polishing composition is improved.

The content of the organic acid surface-immobilized silica particles in the polishing composition is preferably 10 mass % or less, and more preferably 5 mass % or less. As the content of the organic acid surface-immobilized silica particles decreases, there are advantages such as suppressing the agglomeration of organic acid surface-immobilized silica particles, suppressing the occurrence of scratches, and lowering the cost of slurry.

In the present invention, it is indispensable to use the “organic acid surface-immobilized silica particles” as abrasive grains, but in some cases, silica particles not having an organic acid immobilized on the surface thereof may be used in combination therewith. However, the content ratio of the “organic acid surface-immobilized silica particles” to the total abrasive grains is preferably 50 mass % or more, more preferably 80 mass % or more, further preferably 90 mass % or more, particularly preferably 95 mass % or more, and most preferably 100 mass % or more. Also, when only the “silica particles not immobilizing organic acid on the surface thereof” is used as abrasive grains, it is not preferable because defect performance is deteriorated due to aggregates.

[Wetting Agent]

The “wetting agent” contained in the polishing composition according to the present invention has an effect of changing the wettability of the surface from hydrophobicity to hydrophilicity by adsorbing on the surface of a material having a silicon-silicon bond and. The wetting agent used in the present invention is not particularly limited as long as it has the above-mentioned effect, but an example thereof includes a water-soluble polymer. As the water-soluble polymer, one having at least one functional group selected from a nonionic group, an anionic group, and a cationic group in the molecule can be used. Examples of the water-soluble polymer include those containing a hydroxyl group, a carboxy group, an acyloxy group, a sulfo group, a quaternary ammonium structure, a heterocyclic structure, a vinyl structure, a polyoxyalkylene structure, or the like in the molecule. Specific examples of the water-soluble polymer include vinyl alcohol polymers such as polyvinyl alcohol and derivatives thereof, starch derivatives, cellulose derivatives, polymers containing N-(meth)acryloyl type monomer units, polycarboxylic acids or derivatives thereof, polymers containing oxyalkylene units, polymers containing N-vinyl type monomer units, and imine derivatives. Among these, water-soluble polymers in each which a hydrophilic group such as —OH, —COOH, or —NH₂ is adsorbed on the surface of a material having a silicon-silicon bond toward a liquid are preferable.

Preferable examples of the water-soluble polymer include nonionic water-soluble polymers such as polyvinyl alcohol (PVA), pullulan, and hydroxyethyl cellulose; anionic water-soluble polymers such as polyacrylic acid and carboxymethyl cellulose; and cationic water-soluble polymers such as polyacrylamide and the like.

The water-soluble polymers can be used alone or as a combination of two or more kinds.

In a preferred embodiment of the present invention, the wetting agent is at least one selected from the group consisting of polyvinyl alcohol, pullulan, hydroxyethyl cellulose, polyacrylic acid, carboxymethyl cellulose, and polyacrylamide.

The wetting agent is preferably a nonionic water-soluble polymer from the viewpoint that the aggregation of the organic acid surface-immobilized silica particles can be suppressed and the adsorption of the wetting agent to a material having a silicon-nitrogen bond can be suppressed.

Accordingly, in a more preferred embodiment of the present invention, the wetting agent is at least one selected from the group consisting of polyvinyl alcohol, pullulan, and hydroxyethyl cellulose.

In a further preferred embodiment of the present invention, the wetting agent is polyvinyl alcohol.

The lower limit of the weight average molecular weight of the wetting agent is preferably 1,000 or more, more preferably 2,000 or more, and further preferably 3,000 or more, because a strong adsorption film can be obtained as the number of functional groups adsorbed on the substrate (object to be polished) increases. The upper limit of the weight average molecular weight of the wetting agent is preferably 300,000 or less, more preferably 200,000 or less, and further preferably 150,000 or less, because it is necessary to uniformly adsorb onto the substrate (object to be polished). The weight average molecular weight of the wetting agent can be measured, for example, by gel permeation chromatography (GPC).

The lower limit of the content of the wetting agent in the polishing composition is preferably 0.1 g/kg or more, and more preferably 1.5 g/kg or more, from the viewpoint of improving the wettability of the substrate (object to be polished). The upper limit of the content of the wetting agent in the polishing composition is preferably 5.0 g/kg or less, and more preferably 3.0 g/kg or less, from the viewpoint of decreasing a polishing speed due to decrease in friction force.

[Polishing Speed Inhibitor for Material Having Silicon-Silicon Bond]

The “polishing speed inhibitor for a material having a silicon-silicon bond” (also simply referred to as a “polishing speed inhibitor” in this specification) contained in the polishing composition according to the present invention can adsorb to the surface of the material having a silicon-silicon bond to form a protective film and has an effect of inhibiting (retarding) the mechanical polishing action by the organic acid surface-immobilized silica particles. The polishing speed inhibitor used in the present invention is not particularly limited as long as it has the above-mentioned effect, but examples thereof include a nonionic compound and an anionic compound, among which a compound containing a polyoxyalkylene chain is preferable. Further, the polishing speed inhibitor is preferably a nonionic compound from the viewpoint that there is no electrostatic adsorption to another film (other than a material having a silicon-silicon bond).

Examples of the polishing speed inhibitor include nonionic compounds such as polypropylene glycol (PPG), polyethylene glycol (PEG), polyoxyethylene nonylphenyl ether (POE nonylphenyl ether), and polyglycerin; and anionic compounds such as polyoxyethylene lauryl sulfate (POE lauryl sulfate) and the like.

In a preferred embodiment of the present invention, the polishing speed inhibitor is at least one selected from the group consisting of polypropylene glycol, polyethylene glycol, POE nonylphenyl ether, polyglycerin, and POE lauryl sulfate.

In a more preferred embodiment of the present invention, the polishing speed inhibitor is at least one of polypropylene glycol and polyethylene glycol.

The lower limit of the weight average molecular weight of the polishing speed inhibitor is not particularly limited as long as it can suppress the polishing speed of the material having a silicon-silicon bond, but is, for example, 100 or more. The upper limit of the weight average molecular weight of the polishing speed inhibitor is preferably 2000 or less, and more preferably 1000 or less, from the viewpoint of suppression of aggregation of organic acid surface-immobilized silica particles. The weight average molecular weight of the polishing speed inhibitor can be measured, for example, by gel permeation chromatography (GPC).

The content of the polishing speed inhibitor in the polishing composition can be appropriately adjusted depending on the compound to be used. The content of the polishing speed inhibitor is, for example, 0.1 g/kg to 10.0 g/kg.

When PPG is used as the polishing speed inhibitor, the lower limit of the content of PPG in the polishing composition is, for example, more than 1.0 g/kg, preferably 1.3 g/kg or more, and more preferably 1.4 g/kg or more. The upper limit of the content of PPG in the polishing composition is, for example, less than 2.0 g/kg, preferably 1.7 g/kg or more, and more preferably 1.6 g/kg or more. Further, when PEG is used as the polishing speed inhibitor, the lower limit of the content of PEG in the polishing composition is, for example, 0.5 g/kg or more, and preferably 0.8 g/kg or more. The upper limit of the content of PEG in the polishing composition is, for example, 1.2 g/kg or less, and preferably 1.0 g/kg or less.

[Dispersing Medium or Solvent]

The polishing composition of the present invention preferably contains water as a dispersing medium or a solvent. From the viewpoint of preventing the influence of impurities on other components of the polishing composition, it is preferable to use high-purity water as much as possible. Specifically, pure water, ultrapure water, or distilled water from which foreign substances are removed through a filter after removing impurity ions with an ion exchange resin is preferable. Further, as the dispersing medium or solvent, an organic solvent or the like may be further contained in the polishing composition for the purpose of controlling the dispersibility of other components of the polishing composition.

[Inorganic Acid Salt or Organic Acid Salt]

The polishing composition according to the present invention may contain an inorganic acid salt or an organic acid salt. The inorganic acid salt or the organic acid salt can increase the conductivity of the polishing composition, has an action of making the abrasive grains easily approach the object to be polished by reducing the thickness of an electrostatic repulsion layer on the surface of abrasive grains and can improve the polishing speed of an object to be polished by the polishing composition.

Examples of the inorganic acid salt or the organic acid salt include inorganic acid salts such as ammonium sulfate, ammonium nitrate, potassium chloride, sodium sulfate, potassium nitrate, potassium carbonate, potassium tetrafluoroborate, potassium pyrophosphate, and potassium hexafluorophosphate; and organic acid salts such as potassium oxalate, trisodium citrate, and (+)-potassium tartrate. The inorganic acid salt or the organic acid salt can be used alone or as a mixture of two or more.

The content of the inorganic acid salt or the organic acid salt in the polishing composition is preferably 0.1 g/kg or more, and more preferably 0.5 g/kg or more, based on the total mass of the polishing composition. Further, the content of the inorganic acid salt or the organic acid salt is preferably 10 g/kg or less, and more preferably 5 g/kg or less, based on the total mass of the composition.

[pH Adjusting Agent]

The pH value of the polishing composition according to the present invention is less than 7. When the pH value is 7 or more, it is not preferable because the polishing speed of a material having a silicon-nitrogen bond and the polishing speed of a material having a silicon-oxygen bond are decreased.

The pH value of the polishing composition is preferably 6 or less, and more preferably 5.5 or less, from the viewpoint of making the polishing speeds of the respective materials substantially equal to each other.

The lower limit of the pH value of the polishing composition is not particularly limited, but is preferably 1 or more, more preferably 3 or more, and further preferably 4.5 or more, from the viewpoint of safety.

The polishing composition according to the present invention may further contain a pH adjusting agent in order to adjust the pH thereof to less than 7.

As the pH adjusting agent, the following acids or chelating agents can be used.

As an acid, an organic acid and an inorganic acid are exemplified. Examples of the organic acid include carboxylic acids such as formic acid, acetic acid, propionic acid, butyric acid, valeric acid, caproic acid, enanthic acid, caprylic acid, pelargonic acid, capric acid, lauric acid, myristic acid, palmitic acid, margaric acid, stearic acid, oleic acid, linoleic acid, linolenic acid, arachidonic acid, docosahexaenoic acid, eicosapentaenoic acid, lactic acid, malic acid, citric acid, benzoic acid, phthalic acid, isophthalic acid, terephthalic acid, salicylic acid, gallic acid, mellitic acid, cinnamic acid, oxalic acid, malonic acid, succinic acid, glutaric acid, adipic acid, fumaric acid, maleic acid, aconitic acid, amino acid, and nitrocarboxylic acid; and sulfonic acids such as methanesulfonic acid, ethanesulfonic acid, benzenesulfonic acid, p-toluenesulfonic acid, 10-camphorsulfonic acid, isethionic acid, and taurine. Examples of the inorganic acid include carbonic acid, hydrochloric acid, nitric acid, phosphoric acid, hypophosphorous acid, phosphorous acid, phosphonic acid, sulfuric acid, boric acid, hydrofluoric acid, orthophosphoric acid, pyrophosphoric acid, polyphosphoric acid, metaphosphoric acid, and hexametaphosphoric acid.

As a chelating agent, polyamine, polyphosphonic acid, polyaminocarboxylic acid, and polyaminophosphonic acid are exemplified.

These pH adjusting agents can be used alone or as a mixture of two or more kinds. Among these pH adjusting agents, maleic acid is preferable.

The amount of the pH adjusting agent to be added is not particularly limited, and may be appropriately selected such that the pH is within the above range.

[Other Components]

The polishing composition of the present invention may further contain other components such as a complexing agent, a metal anticorrosive, an antiseptic agent, an antifungal agent, an oxidizing agent, a reducing agent, a surfactant, a water-soluble polymer, and an organic solvent for dissolving a sparingly soluble organic substance, if necessary. Hereinafter, descriptions are given for an oxidizing agent, a metal anticorrosive, and an antiseptic agent and an antifungal agent, which are the preferred other components.

(Oxidizing Agent)

The oxidizing agent which can be added to the polishing composition has a function of oxidizing the surface of an object to be polished and it can enhance the polishing speed of an object to be polished by the polishing composition.

Examples of the oxidizing agent which can be used include hydrogen peroxide, sodium peroxide, barium peroxide, organic oxidizing agent, ozone water, silver (II) salt, iron (III) salt, permanganese acid, chromic acid, dichromatic acid, peroxodisulfuric acid, peroxophosphoric acid, peroxosulfuric acid, peroxoboric acid, performic acid, peracetic acid, perbenzoic acid, perphthalic acid, hypochlorous acid, hypobromic acid, hypoiodic acid, chloric acid, chlorous acid, perchloric acid, bromic acid, iodic acid, periodic acid, persulfuric acid, dichloroisocyanuric acid, and salts thereof. These oxidizing agents may be used alone or as a mixture of two or more kinds thereof. Among these, hydrogen peroxide, ammonium persulfate, periodic acid, hypochlorous acid, and sodium dichloroisocyanurate are preferable.

The content of the oxidizing agent in the polishing composition is preferably 0.1 g/L or more, more preferably 1 g/L or more, and further preferably 3 g/L or more. As the content of the oxidizing agent increases, the polishing speed of an object to be polished by the polishing composition is further enhanced.

Furthermore, the content of the oxidizing agent in the polishing composition is preferably 200 g/L or less, more preferably 100 g/L or less, and further preferably 40 g/L or less. As the content of the oxidizing agent decreases, the cost involved with materials of the polishing composition can be saved and a load involved with treatment of the polishing composition after use, that is, a load involved with waste water treatment, can be reduced. It is also possible to lower the possibility of having excessive oxidation of the surface of an object to be polished by the oxidizing agent.

(Metal Anticorrosive)

By adding a metal anticorrosive to the polishing composition, it is possible to further suppress generation of a recess on a side of the wiring by polishing using the polishing composition. In addition, it is possible to further suppress an occurrence of dishing on the surface of the object to be polished after the object to be polished is polished using the polishing composition.

The metal anticorrosive which can be used is not particularly limited, but is preferably a heterocyclic compound or a surfactant. The number of members of the heterocyclic ring in the heterocyclic compound is not particularly limited. Furthermore, the heterocyclic compound may be a monocyclic compound or a polycyclic compound having a condensed ring. The metal anticorrosive maybe used alone or as a mixture of two or more kinds thereof. As the metal anticorrosive, a commercially available product or a synthetic product may be used.

Specific examples of the heterocyclic compound which can be used as the metal anticorrosive include nitrogen-containing heterocyclic compounds such as a pyrrole compound, a pyrazole compound, an imidazole compound, a triazole compound, a tetrazole compound, a pyridine compound, a pyrazine compound, a pyridazine compound, a pyrindine compound, an indolizine compound, an indole compound, an isoindole compound, an indazole compound, a purine compound, a quinolizine compound, a quinoline compound, an isoquinoline compound, a naphthyridine compound, a phthalazine compound, a quinoxaline compound, a quinazoline compound, a cinnoline compound, a buteridin compound, a thiazole compound, an isothiazole compound, an oxazole compound, an isoxazole compound, and a furazan compound.

(Antiseptic Agent and Antifungal Agent)

Examples of the antiseptic agent and antifungal agent that can be added to the polishing composition according to the present invention include isothiazoline-based antiseptic agents such as 2-methyl-4-isothiazolin-3-one and 5-chloro-2-methyl-4-isothiazolin-3-one, paraoxybenzoate esters, and phenoxyethanol. These antiseptic agents and antifungal agents may be used alone or as a mixture of two or more kinds thereof.

<Method for Producing Polishing Composition>

The method for producing the polishing composition of the present invention is not particularly limited. For example, the polishing composition can be obtained by stirring and mixing organic acid surface-immobilized silica particles, a wetting agent, and a polishing speed inhibitor of a material having a silicon-silicon bond and, optionally an inorganic acid salt or an organic acid salt and/or other components in a dispersing medium or in a solvent. The pH adjusting agent can be appropriately used in order to make the pH of the polishing composition less than 7.

The temperature at which the respective components are mixed is not particularly limited, but is preferably from 10° C. to 40° C., and heating may be carried out for increasing a rate of dissolution.

<Polishing Method Using Polishing Composition>

According to another embodiment, there is provided a polishing method in which an object to be polished, the object containing a material having a silicon-silicon bond, a material having a silicon-nitrogen bond, and a material having a silicon-oxygen bond, is polished by using the polishing composition of the present invention.

As a polishing apparatus, it is possible to use a general polishing apparatus provided with a holder for holding a substrate or the like having an object to be polished, a motor or the like which can change a rotation speed, and a polishing table to which a polishing pad (polishing cloth) can be attached.

As the polishing pad, a general nonwoven fabric, polyurethane, a porous fluororesin, or the like can be used without any particular limitation. The polishing pad is preferably groove-processed such that the polishing composition can be stored therein.

Polishing conditions are not particularly limited, either. For example, the rotation speed of platen (table) and head (carrier) is preferably 10 rpm to 500 rpm, and the pressure (polishing pressure) applied to a substrate having an object to be polished is preferably 0.1 psi to 10 psi. A method for supplying the polishing composition to a polishing pad is not particularly limited, either. For example, a method in which the polishing composition is supplied continuously using a pump or the like can be employed. The supply amount is not limited, but a surface of the polishing pad is preferably covered all the time with the polishing composition of the present invention. Further, polishing time is not particularly limited, either.

Details of the polishing composition and the object to be polished, and the like are the same as those having been described in the explanation of the polishing composition and the method for producing the polishing composition.

<Method for Producing Polished Object>

According to still another embodiment of the present invention, there is provided a method for producing a polished object including a step of polishing an object to be polished, the object containing a material having a silicon-silicon bond, a material having a silicon-nitrogen bond, and a material having a silicon-oxygen bond, by using the polishing composition or polishing method of the present invention.

It is preferable that the method for producing a polished object has a step of cleaning and drying the object to be polished after the polishing step.

Details of the polishing composition and the object to be polished, and the like are the same as those having been described in the explanation of the polishing composition, the method for producing the polishing composition, and the polishing method.

### EXAMPLES

The present invention will be described in more detail with the following Examples and Comparative Examples. However, the technical scope of the present invention is not limited to the following Examples. Furthermore, unless specifically described otherwise, “%” and “parts” indicate “mass %” and “parts by mass”, respectively. Furthermore, unless specifically described otherwise, operations of the following Examples were carried out under conditions of room temperature (25° C.)/relative humidity RH of 40% to 50%.

<Preparation of Polishing Composition>

Polishing compositions of Examples 1 to 4 and Comparative Examples 1 and 2 were obtained by selecting organic acid surface-immobilized silica particles (abrasive grains), a wetting agent, a polishing speed inhibitor of a material having a silicon-silicon bond (polishing speed inhibitor), and an inorganic acid salt to have the composition shown in Table 1, adding the selected components to pure water as a solvent and performing stirring and mixing (mixing temperature: about 25° C., mixing time: about 10 minutes). The “−” indicates that it is not added. The pH of the polishing composition was adjusted by a pH adjusting agent shown in Table 1, and was confirmed by a pH meter (model number: LAQUA, manufactured by HORIBA Ltd.).

TABLE 1

| | | | Wetting agent | | | Polishing speed inhibitor | | | | | | |
|---|---|---|---|---|---|---|---|---|---|---|---|---|
| | Abrasive grains | | | | Weight | | | Weight | Inorganic acid salt | | | |
| | | Concen- | | Concen- | average | | Concen- | average | | Concen- | pH | |
| | | tration | | tration | molecular | | tration | molecular | | tration | adjusting | |
| | Type | (mass %) | Type | (g/kg) | weight | Type | (g/kg) | weight | Type | (g/kg) | agent | pH |
| Example 1 | A | 4 | PVA | 2.0 | 10000 | PPG | 1.5 | 400 | Ammonium | 1.0 | Maleic | 5 |
| | | | | | | | | | sulfate | | acid | |
| Example 2 | A | 4 | PVA | 2.0 | 10000 | PEG | 1.0 | 400 | Ammonium | 1.0 | Maleic | 5 |
| | | | | | | | | | sulfate | | acid | |
| Example 3 | A | 4 | PVA | 2.0 | 5000 | PEG | 1.5 | 400 | Ammonium | 1.0 | Maleic | 5 |
| | | | | | | | | | sulfate | | acid | |
| Example 4 | A | 4 | PVA | 2.0 | 100000 | PEG | 1.5 | 400 | Ammonium | 1.0 | Maleic | 5 |
| | | | | | | | | | sulfate | | acid | |
| Comparative | A | 4 | — | — | — | — | — | — | Ammonium | 1.0 | Maleic | 5 |
| Example 1 | | | | | | | | | sulfate | | acid | |
| Comparative | A | 4 | PVA | 2.0 | 10000 | — | — | — | Ammonium | 1.0 | Maleic | 5 |
| Example 2 | | | | | | | | | sulfate | | acid | |

A: colloidal silica immobilized on surface with sulfonic acid (average primary particle size: 35 nm, average secondary particle size: 70 nm)
PVA: polyvinyl alcohol
PPG: polypropylene glycol
PEG: polyethylene glycol

<Polishing Performance Evaluation>

Polishing performance was evaluated using the polishing compositions obtained above. Objects to be polished and polishing conditions are as follows.

(Objects to be Polished)

300 mm wafer: silicon nitride (SiN)

300 mm wafer: tetraethyl orthosilicate (TEOS)

300 mm wafer: polysilicon (Poly-Si)

(Polishing Conditions)

Polishing machine: 300 mm polishing machine (model number F-REX 300 E, manufactured by EBARA Corporation)

Polishing pad: Pad made of polyurethane (model number IC1010, manufactured by Dow Electronic Materials Company)

Pressure: 2 psi

Conditioner (dresser): Diamond dresser (model number A 188, manufactured by 3M Corporation)

Platen (table) rotation speed: 60 rpm

Head (carrier) rotation speed: 65 rpm

Flow rate of polishing composition: 300 ml/min

Polishing time: 60 sec

[Polishing Speed]

Polishing speed (polishing rate) was calculated by the following Equation.

$$Polishing rate [ Å \text{/} min ] = \frac{\begin{matrix}Film thickness before polishing [ Å ] - \\ Film thickness after polishing [ Å ]\end{matrix}}{Polishing time [ min ]} \qquad [ Mathematical Formula 1 ]$$

Film thickness was obtained by using a light interference type film thickness measurement apparatus (model number: ASET F5X, manufactured by KLA-Tencor Corporation).

[Number of Defects]

The total number of defects having a size of 0.16 μm or more remaining on the surface of the polished object was measured by using the SP-1 manufactured by KLA-Tencor Corporation.

The evaluation results of the polishing compositions of Examples 1 to 4 and Comparative Examples 1 and 2 are shown in Table 2 below.

TABLE 2

| | | Polishing speed (Å/min) | | | |
|---|---|---|---|---|---|
| | Number of | Silicon | | | Selection |
| | defects | nitride | TEOS | Poly-Si | ratio |
| Example 1 | 185 | 217 | 220 | 192 | 1.0:1.0:0.9 |
| Example 2 | 220 | 210 | 215 | 206 | 1.0:1.0:1.0 |
| Example 3 | 160 | 210 | 225 | 192 | 1.0:1.1:0.9 |
| Example 4 | 135 | 207 | 222 | 178 | 1.0:1.1:0.9 |
| Comparative | 34959 | 205 | 211 | 194 | 1.0:1.0:0.9 |
| Example 1 | | | | | |
| Comparative | 120 | 224 | 223 | 402 | 1.0:1.0:1.8 |
| Example 2 | | | | | |

Selection ratio: ratio of polishing speed of TEOS and polysilicon to polishing speed of silicon nitride

As apparent from Table 2 above, it was found that, when the polishing compositions (Examples 1 to 4) of the present invention are used, defects can be sufficiently removed, compared to the polishing composition of Comparative Example 1. Further, it was found that the polishing speeds of the respective materials (silicon nitride, TEOS, and Poly-Si) can be made substantially equal to each other, compared to the polishing composition of Comparative Example 2.

This application is based upon the Japanese Patent Application No. 2016-060631, filed on Mar. 24, 2016, and the entire disclosed contents of which are incorporated herein by reference.

1. A polishing composition used for polishing an object to be polished containing a material having a silicon-silicon bond, a material having a silicon-nitrogen bond, and a material having a silicon-oxygen bond, the polishing composition comprising:
organic acid surface-immobilized silica particles;
a wetting agent; and
a polishing speed inhibitor for the material having a silicon-silicon bond,
wherein the polishing composition has a pH of less than 7.

2. The polishing composition according to claim 1, wherein the organic acid is a sulfonic acid or a carboxylic acid.

3. The polishing composition according to claim 1, wherein the wetting agent is at least one selected from the group consisting of polyvinyl alcohol, pullulan, hydroxyethyl cellulose, polyacrylic acid, carboxymethyl cellulose, and polyacrylamide.

4. The polishing composition according to claim 1, wherein the polishing speed inhibitor for the material having a silicon-silicon bond is at least one selected from the group consisting of polypropylene glycol, polyethylene glycol, polyoxyethylene nonylphenyl ether, polyglycerin, and polyoxyethylene lauryl sulfate.

5. The polishing composition according claim 1, further comprising an inorganic acid salt or an organic acid salt.

6. The polishing composition according to claim 1, further comprising a pH adjusting agent.

7. A polishing method comprising: polishing an object to be polished containing a material having a silicon-silicon bond, a material having a silicon-nitrogen bond, and a material having a silicon-oxygen bond by using the polishing composition according to claim 1.

8. A method for producing a polished object comprising: polishing an object to be polished containing a material having a silicon-silicon bond, a material having a silicon-nitrogen bond, and a material having a silicon-oxygen bond by using the polishing composition according to claim 1.
